(19) United States
(12) Patent Application Publication
(10) Pub. No.: US 2026/0339420 A1
(43) Pub. Date: Oct. 29, 2026

(54) OPERATION DEVICE, METHOD FOR CONTROLLING THE SAME, INFORMATION PROCESSING APPARATUS, AND PROGRAM

(71) Applicant: Sony Interactive Entertainment Inc., Tokyo (JP)

(72) Inventors: Makoto Wakabayashi, Tokyo (JP); Keiji Togawa, Tokyo (JP); Hirotomo Yunoki, Tokyo (JP)

(21) Appl. No.: 19/157,113

(22) PCT Filed: Feb. 22, 2023
(86) PCT No.: PCT/JP2023/006526

§ 371 Date: Aug. 15, 2025

(51) Int. Cl. G06F 3/01; G05D 3/10

(52) U.S. Cl. CPC G06F 3/01; G05D 3/10

(57) ABSTRACT

There is provided an operation device including an operation member (20) that is capable of being tilted or moved within a prescribed range by a user, a position detection unit that detects the position of the operation member (20) operated by the user, a drive unit that drives the operation member (20), and a control unit (151) that drives the drive unit such that the operation member (20) approaches a prescribed target position, and changes the target position according to the position of the operation member (20) detected by the position detection unit.

### TECHNICAL FIELD

The present invention relates to an operation device operated by a user, a control method thereof, an information processing apparatus connected to the operation device, and a program.

### BACKGROUND ART

An operation device is known, which includes an operation member that a user operates by tilting or sliding within a predetermined range, such as an analog stick. By giving an operation input to such an operation member, a user can give directional instructions to an information processing apparatus.

### SUMMARY

### Technical Problem

There are cases where the above-mentioned operation member may be biased by a spring or the like such that the member returns to a reference position when the user releases his/her hand from the member. However, such control to return to the reference position does not always provide a desired operational feeling to the user.

The present invention has been made in consideration of the above-mentioned situation, and one of its objects is to provide an operation device, a control method thereof, an information processing apparatus, and a program that can provide a new operational feeling to a user who operates an operation member that can be tilted or moved within a predetermined range.

### Solution to Problem

An operation device according to an embodiment of the present invention is an operation device that includes an operation member that is capable of being tilted or moved within a predetermined range by a user, a position detection unit that detects the position of the operation member operated by the user, a drive unit that drives the operation member, and a control unit that drives the drive unit such that the operation member approaches a given target position and changes the target position according to the position of the operation member detected by the position detection unit.

A control method for an operation device according to an embodiment of the present invention is a control method for an operation device that includes an operation member that is capable of being tilted or moved within a predetermined range by a user, a position detection unit that detects the position of the operation member operated by the user, and a drive unit that drives the operation member, and the control method drives the drive unit such that the operation member approaches a given target position, and changes the target position according to the position of the operation member detected by the position detection unit.

An information processing apparatus according to an embodiment of the present invention is an information processing apparatus connected to an operation device that includes an operation member that is capable of being tilted or moved within a predetermined range by a user, a position detection unit that detects the position of the operation member operated by the user, and a drive unit that drives the operation member, and the information processing apparatus includes one or more processors, and the one or more processors drive the drive unit such that the operation member approaches a given target position, and instructs the operation device to change the target position according to the position of the operation member detected by the position detection unit.

A program according to an embodiment of the present invention is a program for a computer connected to an operation device including an operation member that is capable of being tilted or moved within a predetermined range by a user, a position detection unit that detects the position of the operation member operated by the user, and a drive unit that drives the operation member, and the program causes the computer to execute processes of driving the drive unit such that the operation member approaches a given target position, and instructing the operation device to change the target position according to the position of the operation member detected by the position detection unit. This program may be provided by being stored in a computer-readable and non-transitory information storage medium.

### BRIEF DESCRIPTION OF DRAWINGS

FIG. 1 is a configuration block diagram illustrating an overall configuration of an information processing system equipped with an operation device according to an embodiment of the present invention.

FIG. 2 is a diagram illustrating a structure of a tilting operation member.

FIG. 3 is a diagram illustrating a reference position of the tilting operation member.

FIG. 4 is a diagram illustrating an example of target position control according to the current position.

FIG. 5 depicts diagrams illustrating an example of target position control according to an amount of tilt.

### DESCRIPTION OF EMBODIMENTS

Hereinafter, an embodiment of the present invention will be described in detail with reference to the drawings.

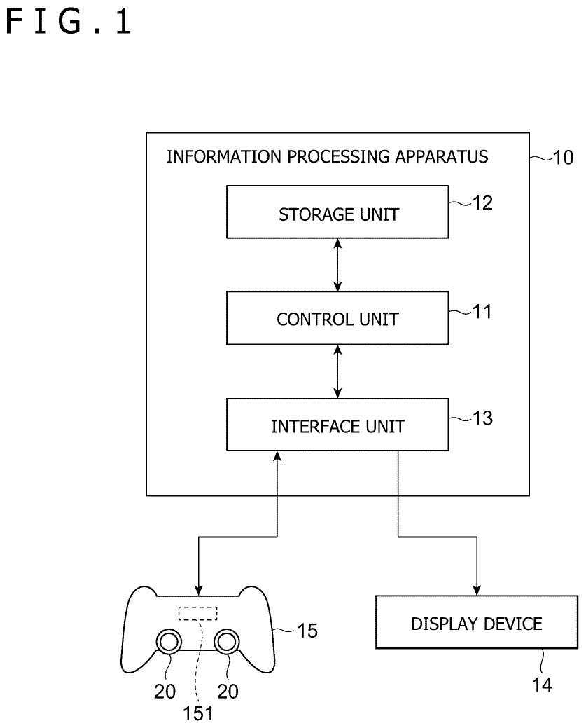

FIG. 1 is a block diagram illustrating a configuration of an information processing apparatus 10 according to an embodiment of the present invention. The information processing apparatus 10 is, for example, a home game machine, a portable game machine, a personal computer, and the like and includes a control unit 11, a storage unit 12, and an interface unit 13 as illustrated in the figure. Further, the information processing apparatus 10 is connected to a display device 14 and an operation device 15.

The control unit 11 includes at least one processor such as a CPU (Central Processing Unit), and executes various types of information processing by executing programs stored in the storage unit 12. Note that specific examples of processing executed by the control unit 11 in the present embodiment will be described later. The storage unit 12 includes at least one memory device such as a RAM (Random Access Memory), and stores the programs executed by the control unit 11 and data processed by the programs.

The interface unit 13 is an interface for data communication with the display device 14 and the operation device 15. The information processing apparatus 10 is connected to each of the display device 14 and the operation device 15 via the interface unit 13 either by wire or wirelessly. To be specific, the interface unit 13 includes a multimedia interface for transmitting video signals supplied by the information processing apparatus 10 to the display device 14. Further, the interface unit 13 includes a data communication interface for receiving signals indicating operation contents performed by the user on the operation device 15. Furthermore, the interface unit 13 may include a communication interface for transmitting and receiving data to and from other communication devices via a communication network such as the Internet.

The display device 14 is a home television receiver or the like, and displays a video image corresponding to the video signal supplied from the information processing apparatus 10 on its screen.

The operation device 15 is a controller for a home game machine or the like, for example, and includes a plurality of operation members for receiving operation input from a user. In addition, the operation device 15 is connected to the information processing apparatus 10 by wire or wirelessly, and transmits and receives various types of data to and from the information processing apparatus 10.

The operation device 15 includes a control unit 151 for controlling each part. The control unit 151 includes at least one processor, and periodically scans contents of operation inputs made by the user to each operation member, thereby transmitting operation signals indicating contents to the information processing apparatus 10. Further, the control unit 151 controls the state of a tilting operation member 20 (to be described later) according to contents of instructions received from the information processing apparatus 10.

In the present embodiment, the operation device 15 is provided with the tilting operation member 20 on its surface as one type of operation member. The tilting operation member 20 is an operation member that the user operates by tilting it with his/her hand or finger, and is configured to be tilted in any direction in a range of 360 degrees. It is to be noted that, in the specific example here, the operation device 15 is provided with a total of two respective tilting operation members 20 on right and left sides. In the following, in a case where it is necessary to distinguish between the left and right tilting operation members 20, the tilting operation member 20 arranged on the left side of the operation device 15 is referred to as a tilting operation member 20L, and the tilting operation member 20 on the right side is referred to as a tilting operation member 20R. The user can independently operate the tilting operation member 20L with the thumb of the left hand and the tilting operation member 20R with the thumb of the right hand, while holding the operation device 15 in his/her hand.

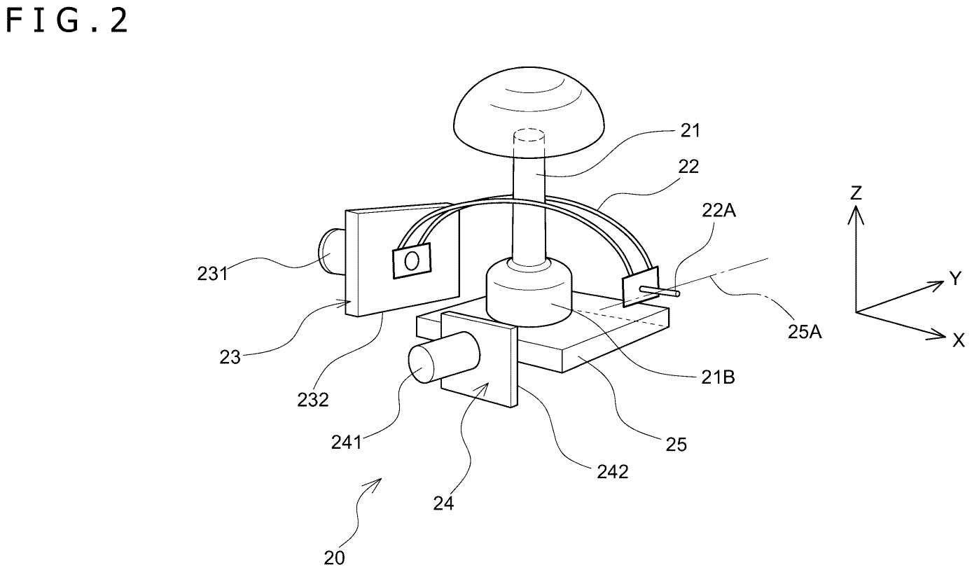

Here, a structure of the tilting operation member 20 will be described. Note that, although the structure of one tilting operation member 20 will be described below, the right and left tilting operation members 20R and 20L have similar configurations. The tilting operation member 20 includes a pillar 21 to be tilted in operation, a guide 22, a first actuator 23, a second actuator 24, and a seat 25, as its outline is illustrated in FIG. 2. Note that, here, it is assumed that the guide 22 and the seat 25 are supported so as to be rotatable around shafts 22A and 25A, respectively, at least within a predetermined angle range, and an X-axis is set in a direction of the shaft 22A, and a Y-axis is set in a direction of the shaft 25A. In addition, the direction perpendicular to both the X-axis and the Y-axis is assumed to be the Z-axis. That is, the guide 22 rotates around the shaft 22A in the YZ plane. Also, the seat 25 rotates around the shaft 25A in the XZ plane.

The guide 22 restricts the movement of the pillar 21 within one direction (the X-axis direction). As described above, the guide 22 is supported so as to be rotatable around the shaft 22A within a predetermined angular range within the YZ plane. This angular range includes an angular range in which the pillar 21 is parallel to the Z-axis direction.

The first actuator 23 and the second actuator 24 function as a drive unit that drives the pillar 21, which is the main body part of the tilting operation member 20, in response to a control signal received from the control unit 151.

To be specific, the first actuator 23 includes a motor 231 and a sensor 232. The motor 231 is a three-phase (having 3n (n is a natural number) stators) brushless DC (direct current) motor, for example, and supplies current input from the control unit 151 to the stator coils of each phase to control an amount 44 rotation, a rotating speed, and a rotational direction of the rotor. The rotating shaft of the rotor of this motor 231 is connected to the shaft 22A of the guide 22, and the motor 231 rotates the guide 22 around the shaft 22A within the YZ plane.

The sensor 232 is a rotary encoder, a potentiometer, or other angle sensor, for example, and sequentially detects a rotation angle θc of the guide 22 around the shaft 22A with a predetermined reference direction (for example, the direction of the guide 22 in a state in which the pillar 21 can be oriented in the positive direction of the Z-axis) set to 0 degrees, and outputs the detection result to the control unit 151.

The second actuator 24 includes a motor 241 and a sensor 242. The motor 241 is a three-phase brushless DC motor similarly to the motor 231, for example, and supplies current input from the control unit 151 to the stator coils of each phase to control the amount of rotation, the rotating speed, and the rotational direction of the rotor. The rotation shaft of the rotor of this motor 241 is connected to the shaft 25A of the seat 25, and the motor 241 rotates the seat 25 around the shaft 25A within the XZ plane.

The sensor 242 is a rotary encoder, a potentiometer, or other angle sensor, for example, and sequentially detects a rotation angle φc of the seat 25 around the shaft 25A with a predetermined reference direction (for example, a direction of the seat 25 in a state where the pillar 21 can be oriented in the positive direction of the Z-axis) set to 0 degrees, and outputs the detection result to the control unit 151.

The seat 25 is supported so as to be rotatable around its shaft 25A within at least a predetermined angular range. In addition, the seat 25 supports a base 21B of the pillar 21 such that the pillar 21 faces in the positive direction of the Z-axis when a rotation angle around the shaft 25A is 0 degrees.

The sensors 232 and 242 function as a position detection unit that detects the position of the tilting operation member 20. The control unit 151 identifies the position of the tilting operation member 20 (i.e., in which direction and at what angle the pillar 21 is tilted) on the basis of the detection results of the sensors 232 and 242. The control unit 151 periodically transmits information indicating the position of the tilting operation member 20 to the information processing apparatus 10 as operation information indicating contents of the operation performed by the user on the tilting operation member 20.

Further, the control unit 151 includes a motor driver that controls the driving of the motor 231 on the basis of the detection result of the sensor 232, and a motor driver that controls the driving of the motor 241 on the basis of the detection result of the sensor 242. The control unit 151 drives the motor 231 and the motor 241 on the basis of an instruction from the information processing apparatus 10, thereby tilting the pillar 21 in any direction and at any angle, and controlling the change of a force required to tilt in a given direction.

It should be noted that, in the following description, it is assumed that the tilting operation member 20 is disposed such that the tilt direction of the pillar 21 caused by the motor 221 coincides with the right-left direction of the operation device 15, and the tilt direction of the pillar 21 caused by the motor 231 coincides with the front-rear direction of the operation device 15. That is, the tilt angle θc of the shaft 22A detected by the sensor 232 represents the tilt of the pillar 21 in the right-left direction of the operation device 15, and the tilt angle φc of the shaft 25A detected by the sensor 242 represents the tilt of the pillar 21 along the front-rear direction of the operation device 15. Then, the position of the tilting operation member 20 is identified by the pair of values of these two tilt angles (θc, φc).

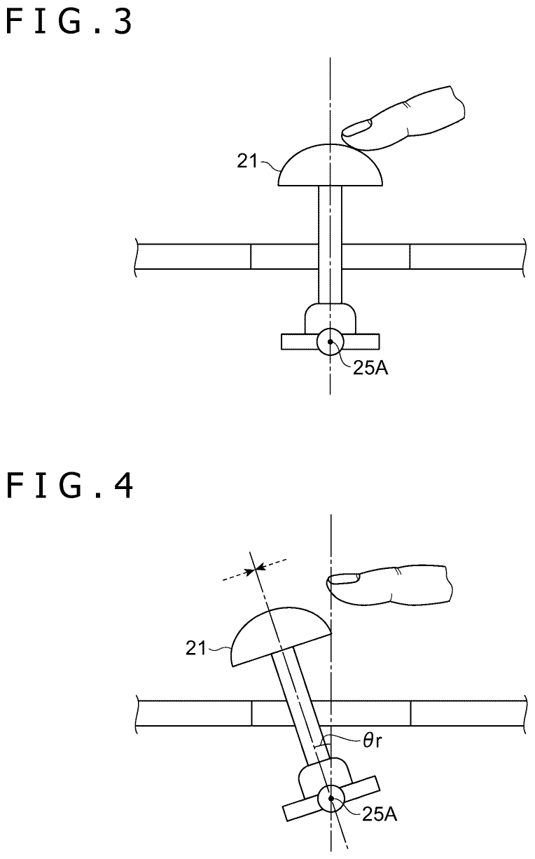

Here, θc and φc each have a value in a range from a given maximum value to minimum value. Therefore, a range of possible values of the pair of (θc, φc) corresponds to a rectangular area in a two-dimensional space. Hereinafter, the range of possible values of this pair of tilt angles is referred to as a movable range of the tilting operation member 20. In reality, the maximum angle at which the pillar 21 can be physically tilted is limited by the housing of the operation device 15 or the like, and there are cases where the physical movable range of the tilting operation member 20 may be a circular range, but here, the range of possible values of the pair of detected tilt angles is assumed to be the movable range. The center position of this movable range (hereinafter, referred to as the reference position O) is a position where θc=0° and φc=0° are satisfied, and corresponds to a state in which the pillar 21 is directed in the positive direction of the Z-axis. FIG. 3 is a diagram illustrating the reference position of the tilting operation member 20, and illustrates a schematic view of the pillar 21 viewed from the side.

The position of the tilting operation member 20 can be expressed by an azimuth angle θd and a tilt amount θr instead of the pair of (θc, φc). Here, the azimuth angle θd indicates the direction to the current position of the tilting operation member 20 as viewed from the reference position O, and has a value of 0° or more and less than 360° with a given direction as the reference direction. The tilt amount θr indicates the rotation angle of the pillar 21 from the positive direction of the Z-axis so as to indicate 0° when the pillar 21 is at the reference position O, and the value increases as the pillar 21 moves away from the reference position O. In other words, the azimuth angle θd indicates the direction of change of the position of the tilting operation member 20 due to the user's operation as viewed from the reference position O, and the tilt amount θr indicates the amount of change of the position of the tilting operation member 20 from the reference position O due to the user's operation.

In the present embodiment, in a case where there is no particular instruction from the information processing apparatus 10, the control unit 151 controls the pillar 21 to move toward the target position, with the reference position O as the target position. That is, when the user is not applying a force to the pillar 21, the control unit 151 controls the motors 231 and 241 to move the pillar 21 toward the reference position O, and ends the drive control in a case where the pillar 21 reaches the reference position O. As a result, the tilting operation member 20 returns to the reference position O when the user releases his/her hand therefrom no matter what position the member is in, and becomes stationary at the reference position O.

In contrast, in the case of reception of a special instruction from the information processing apparatus 10, the control unit 151 performs control to change the target position of the pillar 21 according to the current position of the pillar 21. Hereinbelow, some specific examples of the control of the target position performed by the control unit 151 in the present embodiment will be described.

First, as a first example, an example of controlling the pillar 21 so as to continuously set the current position of the pillar 21 as the target position will be described. In this first example, when the position of the pillar 21 changes, the control unit 151 updates the target position such that the current position after the change always becomes the new target position. With this type of control, no matter what position the user moves the pillar 21 to, when the user releases his/her hand from the pillar 21, the drive control is performed such that the position at this time is maintained. This makes it easier for the user to perform an operation to keep the pillar 21 stationary at any position.

FIG. 4 is a diagram illustrating the state of control in this first example, and illustrates a schematic side view of the pillar 21. The example of this figure illustrates the posture of the pillar 21 which comes to be maintained at the timing of the user releasing the finger therefrom after the user's operation to tilt the pillar 21.

Note that, in this first example, the control unit 151 may update the target position such that the latest current position becomes the target position whenever scanning the current position of the pillar 21 (i.e., every time the position of the pillar 21 is detected). In this case, control for moving the pillar 21 toward the target position is not performed practically, but control of the motors 231 and 241 is performed such that the pillar 21 continues to stand still at the target position. This makes it possible to present to the user a sensation of frictional resistance when the user is operating the pillar 21.

At this time, the control unit 151 can change a magnitude of a force required for the user to perform an operation to change the position of the pillar 21 by a method such as controlling a magnitude of torque of the motors 231 and 241. When executing the control of the target position according to this first example in response to an instruction from the information processing apparatus 10, the control unit 151 also receives an instruction regarding the strength of a force from the information processing apparatus 10, and controls the motors 231 and 241 according to the indicated magnitude of the force. This makes it possible to change the strength of the force required to operate the tilting operation member 20 according to the contents of the processing executed by the information processing apparatus 10 or an instruction from the user. For example, when the control unit 151 executes control to maintain the target position with a relatively strong force, the user needs a stronger force to tilt the pillar 21, so that the user can be presented with a feeling as if the pillar 21 has become heavier.

Further, the control unit 151 may update the target position less frequently than the frequency of periodically scanning the position of the pillar 21. For example, the control unit 151 may update the latest current position at that time to a new target position every time a given time elapses. Also, every time the current position of the pillar 21 changes by a predetermined amount from the current target position, the target position may be updated with the position at that time. In this way, in a case where the position of the pillar 21 changes only slightly, control is performed to return the pillar 21 to the target position, and in the case where the position of the pillar 21 is changed relatively significantly by the user, control can be performed to update the target position while following the change.

Next, as a second example, a control example in which the target position is changed according to a magnitude of the tilt amount θr of the pillar 21 will be described. As described above, the tilt amount θr of the pillar 21 indicates the amount of change in the position of the pillar 21 from the reference position O due to a user operation. In particular, in the following, the control unit 151 changes the tilt amount θr of the target position (hereinafter referred to as the target tilt amount) according to the magnitude of the tilt amount θr of the current position of the pillar 21, and controls the azimuth angle Od of the target position so as to maintain the current azimuth angle.

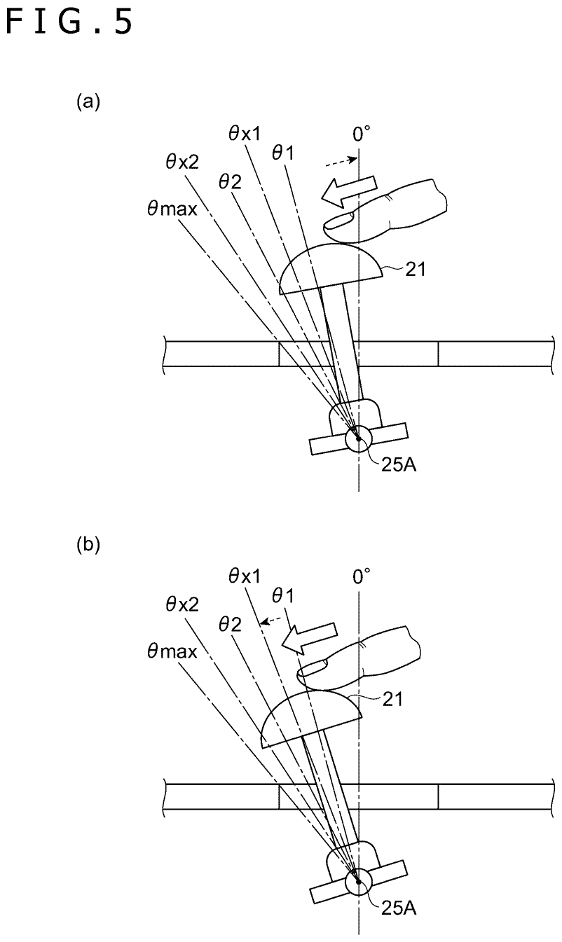

FIG. 5 depicts diagrams illustrating an example of specific control contents in this second example, and are schematic diagrams illustrating a state seen from the side of the pillar 21. Further, in these diagrams, the block arrows indicate the movement direction of the pillar 21 by the user's operation, and the dashed arrows indicate the direction of control by the control unit 151 to move the pillar 21 to a target position.

In the example illustrated in this figure, the control unit 151 divides the range of possible values of the tilt amount θr of the pillar 21 into a plurality of angle ranges, and changes the target tilt amount depending on which of the plurality of angle ranges includes the current tilt amount θr. To be more specific, the control unit 151 adopts, as the target tilt amount, a predetermined numerical value that belongs to the angle range in which the current tilt amount θr is included.

As an example, in a case where the tilt amount θr of the pillar 21 is included in the angle range of 0°≤θr≤θ1, the control unit 151 sets the target tilt amount to 0°, which is the minimum value of this angle range. In contrast, in a case where the tilt amount θr is included in the angle range of θ1≤θr<θ2, the control unit 151 sets the target tilt amount to an angle θx1 included in this angle range. Here, θx1 may be a value corresponding to the median value of the angle range from θ1 to θ2. In this case, the target tilt amount θx1 is an angle calculated by

θx1=(θ1+θ2)/2.

Further, in a case where the tilt amount θr is included in the angle range of θr≥θ2, the target tilt amount is set to θx2. Here, θx2 may be an angle calculated by

θx2=(θ2+θmax)/2

by using the maximum value θmax of the tilt amount θr (i.e., the maximum tilt angle in the movable range of the pillar 21).

In this example, it is assumed that the user performs an operation to tilt the pillar 21 in any direction from the reference position O. Since the target tilt amount is initially set to 0°, the control unit 151 controls the motors 231 and 241 to apply a force that attempts to return the pillar 21 to the reference position O. Therefore, the user moves the pillar 21 against this force in a direction away from the reference position O. FIG. 5(a) illustrates the state of the pillar 21 at this time.

Thereafter, when the user continues the tilting operation and the tilt amount θr becomes equal to or greater than the threshold value θ1, the control unit 151 changes the target tilt amount to θx1 at that timing. Then, a resistance force that has been presented to the user to return the pillar 21 to the reference position O disappears, and instead, a force that attempts to further tilt the pillar 21 to the target tilt amount θx1 is applied. That is, at a timing when the tilt amount θr reaches the threshold value θ1, the force applied to the pillar 21 momentarily changes to the opposite direction. FIG. 5(b) illustrates the state of the pillar 21 at this time. With such a control, the user feels a response similar to a clicking sensation caused when a mechanical switch is turned on, at a timing when the tilt amount θr of the pillar 21 exceeds the threshold value θ1.

Further, when the user continues the tilting operation and the tilt amount θr exceeds the target tilt amount θx1, the force is started to be presented again in an opposite direction to the user's operation direction. Then, when the tilt amount θr becomes equal to or greater than the threshold value θ2, the direction of the force changes rapidly in a similar way to the moment when the tilt amount θr becomes equal to or greater than the threshold value θ1, and the user is presented with a clicking sensation.

In this control, since the target tilt amount differs depending on the angle range to which the current position of the pillar 21 belongs, even if the user releases his/her hand from the pillar 21, the pillar 21 does not automatically return to the reference position O. However, in a case where the tilt amount θr is within the angle range 0°≤θr<θ1, the reference position O becomes the target position, so that, if the user performs an operation to return the pillar 21 to a position close to the reference position O by him/herself, the pillar 21 can be automatically returned to the reference position O thereafter.

In the above description, for an angle range in which the tilt amount θr is equal to or greater than θ1, the median value of the angle range is set as the target tilt amount. However, the target tilt amount is not limited to this, and the target tilt amount may be set to an angle that is shifted from the median value. For example, by setting the target tilt amount in a case where the tilt amount θr of the pillar 21 is included within a certain angle range to an angle near the reference position O within that angle range (i.e., a relatively small angle), it becomes possible for the user to immediately feel a force that opposes his or her operation in a case where the tilt amount exceeds the target tilt amount.

Note that, here, 0°≤θr≤θmax, which is the range of possible values of the tilt amount θr, is divided into three angle ranges, and the target tilt amounts 0°, θx1, and θx2 are set for the angle ranges, respectively. However, the present invention is not limited to this, and the control unit 151 may divide the range of possible values of the tilt amount θr into two or four or more angle ranges, and may set any target tilt amount for each angle range. Further, in this case, the size of each angle range may be the same as each other, or may be different. By setting the boundaries of the plurality of angle ranges at any positions, the control unit 151 can present the click feeling to the user at any angle. Here, the control unit 151 may determine the size and number of the angle ranges, and the value of the target tilt amount in each angle range, in response to an instruction from the information processing apparatus 10. This allows the information processing apparatus 10 to change the angle at which the click feeling is presented to the user according to the processing contents being executed by the user.

Also in this second example, similarly to the first example, the control unit 151 may change the magnitude of the force applied to move the pillar 21 toward the target position according to an instruction from the information processing apparatus 10. This makes it possible to change the sensation the user feels when crossing the boundary of the angle range. Note that the information processing apparatus 10 may specify different magnitudes for the magnitude of the force applied to move the pillar 21 toward the target position for each of a plurality of angle ranges. This makes it possible to change the sensation that the user feels for each angle.

As described above, according to the operation device 15 of the present embodiment, by changing the target position of the tilting operation member 20 according to the position of the tilting operation member 20, it is possible to present an operating feeling different from normal to the user operating the tilting operation member 20 with relatively simple processing.

It should be noted that the embodiment of the present invention is not limited to the above-described embodiment. For example, the setting contents of the target positions in the above description are merely examples, and the control unit 151 may change the target positions according to various conditions.

In addition, the operation device 15 is not limited to a device that is held and used by the user, but may be a device that is used while placed on a table, etc. In addition, the tilting operation member 20 is also not limited to an operation member that is operated by the user with the thumbs, and may have various shapes and structures, such as an operation member that is operated with other fingers or an operation member that is operated while being gripped by the user in the hand.

Further, the operation device 15 may include an operation member that can be operated to slide in any direction parallel to the surface of the housing within a predetermined range, instead of the tilting operation member 20 that the user operates by tilting motion. Also in this case, by changing the target position on the basis of the amount of change from the current position or a reference position of the operation member (for example, the center position of the movable range of the operation member), it is possible to maintain the operation member at any position or to present the user with a clicking sensation when the amount of change becomes equal to or greater than a predetermined amount.

In addition, in the above description, the control unit 151 performs control to change the target position depending on the position of the tilting operation member 20, but this is not limited to the above, and at least a part of the control that the control unit 151 performs in the above description may be performed by the information processing apparatus 10 that is communicatively connected to the operation device 15.

To be specific, as described above, the operation device 15 periodically transmits operation information indicating the user's operation contents on each operation member of the operation device 15 to the information processing apparatus 10. This operation information includes information indicating the position of the tilting operation member 20 as information indicating the user's operation contents on the tilting operation member 20. The information processing apparatus 10 transmits, to the operation device 15, instruction information for instruction to change the target position of the tilting operation member 20 according to the position of the tilting operation member 20 at that time and to execute drive control to move the pillar 21 toward the target position. The control unit 151 of the operation device 15 executes drive control of the tilting operation member 20 according to this instruction information. Even with this configuration, the target position of the tilting operation member 20 can be changed at any time by transmitting and receiving information between the operation device 15 and the information processing apparatus 10 in a relatively short cycle.

### REFERENCE SIGNS LIST

10: Information processing apparatus
11: Control unit
12: Storage unit
13: Interface unit
14: Display device
15: Operation device
151: Control unit
20: Tilting operation member
21: Pillar
22: Guide
23: First actuator
24: Second actuator
25: Seat

1.-8. (canceled)

9. An operation device comprising:
an operation member that is capable of being tilted or moved within a predetermined range by a user;
a position detection unit that detects a position of the operation member operated by the user;
a drive unit that drives the operation member; and
a control unit that drives the drive unit such that the operation member approaches a target position, and changes the target position according to the position of the operation member detected by the position detection unit.

10. The operation device according to claim 9, wherein the control unit controls the operation member so as to maintain the position of the operation member.

11. The operation device according to claim 10, wherein the control unit controls the operation member by setting the position of the operation member operated by the user as the target position.

12. The operation device according to claim 9, wherein the control unit returns the operation member to a reference position when released from user control.

13. The operation device according to claim 12, wherein, after return to the reference position, the operation member remains stationary.

14. The operation device according to claim 9, wherein the control unit changes the target position according to an amount of change in the position of the operation member from a reference position.

15. The operation device according to claim 14, wherein;
the control unit divides a range of possible amounts of change in the position of the operation member from the reference position into a plurality of numerical ranges; and
changes the target position according to which of the plurality of numerical ranges includes the amount of change.

16. The operation device according to claim 15, wherein, in a case in which the amount of change is included in one of the plurality of numerical ranges, the control unit changes the target position to a position corresponding to a median value of the one of the plurality of numerical ranges.

17. The operation device according to claim 15, wherein the plurality of numerical ranges correspond to a rectangle in two-dimensional space.

18. The operation device according to claim 9, wherein a maximum range of movement for the operation member is limited by a housing of the operation device.

19. The operation device according to claim 18, wherein a physical moveable range of the operation member is a circular range.

20. The operation device according to claim 9, wherein a reference position for the operation member is a center position and corresponds to the operation member directed to a positive direction of a Z-axis.

21. The operation device according to claim 20, wherein the positive direction of a Z-axis is at 0 degrees.

22. The operation device according to claim 9, wherein a position of the operation member is defined by two tilt angle values.

23. The operation device according to claim 9, wherein a position of the operation member is defined by an azimuth angle and a tilt amount.

24. The operation device according to claim 9, wherein, when a special instruction is received, the control unit initiates a change in the target position according to a current position of the operation member.

25. The operation device according to claim 9, wherein the control unit maintains any position the operation member is moved to.

26. A method for controlling an operation device including an operation member that is capable of being tilted or moved within a predetermined range by a user, a position detection unit that detects a position of the operation member operated by the user, and a drive unit that drives the operation member, comprising:
driving the drive unit such that the operation member approaches a target position; and
changing the target position according to the position of the operation member detected by the position detection unit.

27. An information processing apparatus connected to an operation device including an operation member that is capable of being tilted or moved within a predetermined range by a user, a position detection unit that detects a position of the operation member operated by the user, and a drive unit that drives the operation member, comprising:
one or more processors, wherein the one or more processors drives the drive unit such that the operation member approaches a target position: and
instructs the operation device to change the target position according to the position of the operation member detected by the position detection unit.

28. A program for a computer connected to an operation device including an operation member that is capable of being tilted or moved within a predetermined range by a user, a position detection unit that detects a position of the operation member operated by the user, and a drive unit that drives the operation member, comprising:
driving the drive unit such that the operation member approaches a target position; and
instructing the operation device to change the target position according to the position of the operation member detected by the position detection unit.
